(19) United States
(12) Patent Application Publication
(10) Pub. No.: US 2026/0312777 A1
(43) Pub. Date: Oct. 8, 2026

(54) WIRELESS COMMUNICATION APPARATUS, CONTROL METHOD, AND NON-TRANSITORY COMPUTER READABLE STORAGE MEDIUM

(71) Applicant: CANON KABUSHIKI KAISHA, Tokyo (JP)

(72) Inventor: TOSHIYUKI NAKAGAWA, Kanagawa (JP)

(21) Appl. No.: 19/632,793

(22) Filed: Mar. 30, 2026

(30) Foreign Application Priority Data
Apr. 2, 2025 (JP) 2025-061455

(51) Int. Cl. H04L 5/00; H04W 48/16

(52) U.S. Cl. CPC H04L 5/0094; H04L 5/0046; H04W 48/16

(57) ABSTRACT

A wireless communication apparatus capable of communicating with an access point using a wireless frame compliant with an IEEE 802.11 standard series, performs: controlling, based on at least one of an operation status of the access point and a communication environment, whether or not to transmit to the access point a wireless control frame for requesting a start of a Dynamic Subband Operation (DSO) in which a frequency band used in communication between the access point and the wireless communication apparatus is dynamically changed within a range of one operation frequency band used by the access point.

### BACKGROUND

### Field of the Technology

The present disclosure relates to a wireless communication apparatus, a control method, and a non-transitory computer readable storage medium.

### Description of the Related Art

In recent years, with increases in the amount of data communication, the development of wireless local area network (LAN) communication techniques has been proceeding. The Institute of Electrical and Electronics Engineers (IEEE) 802.11 standard series is known as the main communication standard for wireless LAN. The IEEE 802.11 standard series includes standards such as IEEE 802.11a/b/g/n/ac/ax/be, and the like. Development of the IEEE 802.11bn standard as the successor of the IEEE 802.11be standard is advancing with the purpose of further improving communication reliability. In the IEEE 802.11WG (Working Group) that is establishing the IEEE 802.11bn standard, the UHR SG is scheduled to set the purpose and scope of the standard, and the TGbn is scheduled to define the specific content of the technology to be included in the standard. Note that UHR SG is an abbreviation for the Ultra High Reliability Study Group. Also, TGbn is an abbreviation for the Task Group bn. [0003] Technology for efficiently using frequency resources in a communication method using a communication link constituted by a plurality of channels is being looked into as one of the candidate technologies to be included in the IEEE 802.11bn standard. For example, the specification of US-2023-0239743 and the specification of US-2024-0284454 describe that, in a case where the bands (subbands) used by two stations (STA) communicating with an access point (AP) overlap, the AP transmits a trigger frame, and one of the STAs switches the used band to another band. In this manner, communication with the two STAs can be performed in parallel, and the frequency bands can be used effectively. This technology is known as Dynamic Subband Operation (DSO). [0004] In the related art described above, the AP triggering the start of a DSO is described, but it can be expected that in some cases, the AP starts a DSO in response to a request from a STA. However, depending on the AP operation channel and the communication environment, there may be times when a DSO cannot be executed or it is undesirable to execute a DSO. An example of a case where a DSO cannot be executed is a case where the AP operation channel width is 20 MHz and a switch to another subband cannot be performed. An example of a case where it is undesirable to execute a DSO is a case where an AP operates at the 2.4 GHz band because, as the 2.4 GHz band is normally congested, there is little possibility that another subband can be switched to. In such cases, even if the STA transmits a request to start a DSO to the AP, there is a possibility that a DSO cannot be started, and the transmission is wasted communication.[0005] In this manner, there is an issue in that the user-friendliness is poor when a communication apparatus communicating with an access point requests the start of a Dynamic Subband Operation (DSO).

### SUMMARY

A wireless communication apparatus according to an aspect of the present disclosure capable of communicating with an access point using a wireless frame compliant with an IEEE 802.11 standard series, comprising: at least one memory that stores a set of instructions; andat least one processor that executes the instructions, the instructions, when executed, causing the wireless communication apparatus to perform operations comprising: controlling, based on at least one of an operation status of the access point and a communication environment, whether or not to transmit to the access point a wireless control frame for requesting a start of a Dynamic Subband Operation (DSO) in which a frequency band used in communication between the access point and the wireless communication apparatus is dynamically changed within a range of one operation frequency band used by the access point.

According to the present disclosure, the user-friendliness when a communication apparatus that communicates with an access point requests the start of Dynamic Subband Operation (DSO) can be improved.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram illustrating a configuration example of a wireless communication system.

FIG. 2 is a diagram illustrating a hardware configuration example of a STA 110.

FIG. 3 is a diagram illustrating a functional configuration example of the STA 110.

FIG. 4 is a diagram illustrating a sequence example executed when a communication apparatus establishes a connection.

FIG. 5 is a diagram illustrating a configuration example of a UHR Capabilities element.

FIG. 6 is a diagram illustrating a flowchart executed when the STA 110 controls DSO.

FIG. 7 is a diagram illustrating a flowchart executed when the STA 110 determines whether DSO can be performed based on the operation channel of the associated AP.

FIG. 8 is a diagram illustrating an example of a time chart of when uplink direction data communication is performed.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### System Configuration

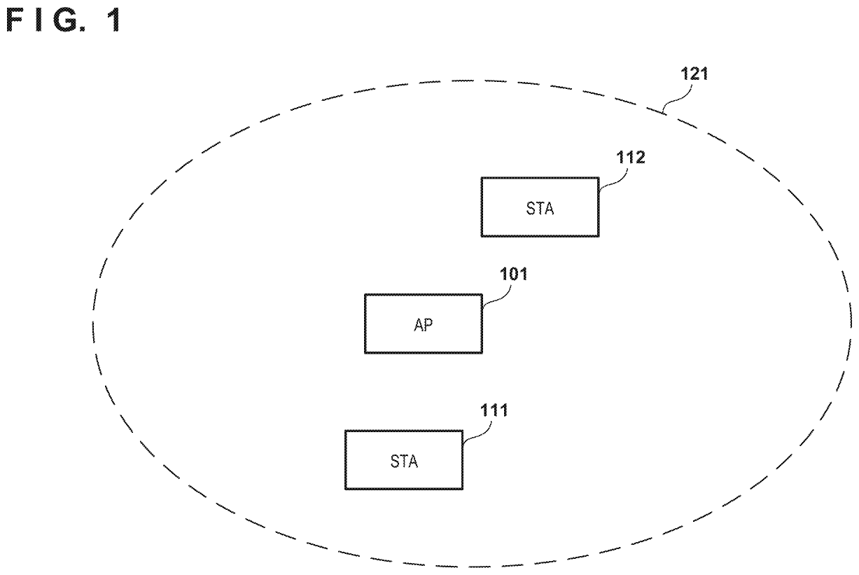

FIG. 1 illustrates a configuration example of a wireless communication system according to the present embodiment. The wireless communication system includes an access point (AP) 101 and a station (STA) 111 and an STA 112, for example. When not distinguishing between the STA 111 and the STA 112, they may be referred to as a STA 110. Also, when not distinguishing between the AP 101 and the STA 110, they may be referred to as a wireless communication apparatus 100. The AP 101 and the STA 110 are each wireless communication apparatuses that can execute wireless communication compliant with the IEEE 802.11 standard series. IEEE is an abbreviation for the Institute of Electrical and Electronics Engineers. FIG. 1 illustrates a configuration in which the STA 111 and the STA 112 join a network 121 established by the AP 101. The network 121 may be referred to as a Basic Service Set (BSS). In the network 121 of FIG. 1, a configuration including one AP 101 and two STA 110 is illustrated. However, a plurality of the APs 101 may exist, and one or three or more of the STAs 110 may exist, for example. Also, at this time, each STA 110 may be connected to one AP 101, or one STA 110 may be connected to the plurality of APs 101.

In the present embodiment, the wireless communication apparatus 100 is configured to be able to execute a communication method compliant with the IEEE 802.11bn standard. The IEEE 802.11bn standard is a successor to the IEEE 802.11be standard with a purpose of 46.08 Gbps (Giga bit per second) for the maximum transmission speed. A main feature of the IEEE 802.11bn standard is that it has a function of achieving high reliability communication, low latency, improvement in throughput when the communication traffic is congested, and the like. The wireless frame used in the communication method compliant with this standard may be referred to as an Ultra High Reliability (UHR) PPDU. PPDU is an abbreviation for a PLCP Protocol Data Unit, and PLCP is an abbreviation for a Physical Layer Convergence Protocol. Note that there is a possibility of the names UHR, IEEE 802.11bn, and the like being changed to a different name after the standard has finished being established. Also, it should be noted that the present embodiment can be applied to a communication apparatus using any and all of the successors to the IEEE 802.11be standard. Also, the wireless communication apparatus 100 may support at least any one of the legacy standards from before the IEEE 802.11bn standard. Legacy standards include IEEE 802.11a/b/g/n/ac/ax/be, for example. Also, the wireless communication apparatus 100 may support other communication standards, such as Bluetooth (registered trademark), NFC, UWB, ZigBee, MBOA, and the like. Note that UWB is an abbreviation for Ultra Wide band, and MBOA is an abbreviation for Multi Band OFDM Alliance. Also, NFC is an abbreviation for Near Field Communication. UWB includes wireless USB, wireless 1394, WiNET, and the like. Also, the wireless communication apparatus 100 may support wired LAN or similar wired communication standards. Examples of the AP 101 include but are not limited to a wireless LAN router, a personal computer (PC), and the like. The AP 101 may be an information processing apparatus such as a radio chip that can execute wireless communication that supports the IEEE 802.11bn standard or the like. For example, the STA 110 is but is not limited to a camera, a tablet, a smartphone, a PC, a mobile phone, a video camera, a headset, smart glasses, a head-mounted display (HMD) or similar wearable device, or the like. The STA 110 may be an information processing apparatus such as a radio chip that can execute wireless communication that supports transmission and reception of PPDUs supporting the IEEE 802.11bn standard or the like. In this case, a configuration can be used in which various types of control are executed by a hardware circuit inside a radio chip. Note that a configuration may be used in which various types of processing are executed by the cooperation between a processor such as an ASIP and a memory inside a radio chip and a hardware circuit. ASIP is an abbreviation for Application-specific instruction set processor.

The wireless communication apparatus 100 may communicate using wireless signals in at least one of the frequency bands including the 2.4 GHz band, the 3.6 GHz band, the 5 GHz band, the 6 GHz band, and millimeter wave bands such as the 45 GHz band and the 60 GHz band. The frequency band used by the wireless communication apparatus 100 is not limited thereto and may be a so-called Sub-1 GHz band including the 315 MHz, the 400 MHz, and the 920 MHz band, for example. Also, the wireless communication apparatus 100 may communicate using bandwidth such as 20 MHz, 40 MHz, 80 MHz, 160 MHz, 320 MHz, 540 MHz, 640 MHz, 1080 MHz, and 2160 MHz. The bandwidth used by the wireless communication apparatus 100 is not limited to these examples and may be 240 MHz, 4 MHz, or the like, for example. Note that in the IEEE 802.11 standard series, a frequency channel that uses the 20 MHz bandwidth is specified as the basic channel for the 2.4 GHZ, 5 GHZ, 6 GHZ, and similar frequency bands. Also, in the standard, a plurality of usable channels are defined for each frequency band including the 2.4 GHz band, the 5 GHz band, and the 6 GHz band. Note that in the standard, the wireless communication apparatus 100 can use a combination of a certain channel and another adjacent channel. Using a combination of a certain channel and another adjacent channel in this manner may be referred to as channel bonding. Also, a bundle of channels formed of one or two or more channels adjacent to one another may be referred to as a communication link (link). In other words, one link formed of two channels of the 20 MHz bandwidth may use the 40 MHz bandwidth. In the IEEE 802.11be standard and successor standards (including the IEEE 802.11bn standard and successor standards), 320 MHz or greater is scheduled to be specified as the maximum bandwidth that can be used for one link. For example, a link using the 320 MHz bandwidth may be constituted by bundling sixteen channels of the 20 MHz bandwidth using channel bonding. Note that the signal transmitted in the range may be consecutive on the frequency axis or may be non-consecutive. Note that the AP 101 and the STA 110 may be an AP Multi-Link Device (MLD) and a STA MLD, respectively, that support Multi-Link in which communication is performed with a plurality of links simultaneously established.

In order to communicate data with another wireless communication apparatus, the wireless communication apparatus 100 establishes one or more links between the apparatuses. For example, the STA 110 executes an association procedure with the AP 101 in order to establish a link with the AP 101. The association procedure, for example, includes a connection request being transmitted by the STA 110 and a connection response being transmitted by the AP 101. When the association procedure is complete, a link is established between the STA 110 and the AP 101. A link being established may be referred to as a connection being established. By establishing a link, the wireless communication apparatus 100 can access a wireless medium and can perform communication of data and the like with a partner wireless communication apparatus. For example, in a case where one link using the 320 MHz bandwidth is established between the wireless communication apparatuses, the wireless communication apparatus 100 may perform communication via channel bonding using a channel that is usable depending on the status of all or a portion of the channels forming the link.

When transmitting a signal using the established link with the other wireless communication apparatus, the wireless communication apparatus 100 determines whether the signal can be transmitted by executing carrier sense. Carrier sense is an operation in which the wireless communication apparatus 100 determines whether or not a signal exists on the channel that the wireless communication apparatus 100 is trying to use for transmission. For example, the wireless communication apparatus 100 measures the strength (received signal strength) of the signal received on the channel and, in a case where the received signal strength is greater than a predetermined threshold, determines that a signal exists on the channel (physical carrier sense). The received signal strength may also be referred to as the Received Signal Strength Indicator (RSSI). Also, the wireless communication apparatus 100 may determine whether or not a signal exists based on information such as a Duration field included in the signal received on the channel (virtual carrier sense). For example, the wireless communication apparatus 100 stores the time period indicated by the Duration field included in the received signal in the wireless communication apparatus 100 as a Network Allocation Vector (NAV). The wireless communication apparatus 100 may treat the stored NAV as a time period in which the wireless communication apparatus 100 does not transmit. In the present embodiment, the operation of setting the time period in which the wireless communication apparatus 100 does not transmit based on information such as the duration field of the received signal by the wireless communication apparatus 100 may be referred to as setting the NAV. In other words, in the time period up until the NAV set for the channel expires, the wireless communication apparatus 100 determines that a signal exists on the channel. In this manner, the wireless communication apparatus 100 determines whether or not a signal is on the channel based on the result of executing a physical carrier sense and a virtual carrier sense. In a case where the wireless communication apparatus 100 determines that a signal exists on the channel, the channel may be determined to be in an unavailable-for-transmission state. The state of the channel in this case may be referred to as a busy state. On the other hand, a state in which a signal is not detected on a channel in carrier sense and the NAV is not set may be referred to as an idle state. In a case where the channel is in the idle state, the wireless communication apparatus 100 may determine that the channel is in an available-for-transmission state.

When the wireless communication apparatus 100 transmits using a link with a predetermined bandwidth, the wireless communication apparatus 100 may determine whether or not transmission can be performed using only the primary channel (PCH) with a bandwidth of 20 MHz included in the link. For example, the PCH is one of the 16 channels with a bandwidth of 20 MHz forming the link with a bandwidth of 320 MHz. In this case, the wireless communication apparatus 100 may determine that it is unavailable for transmission based on the PCH being in the busy state and may determine that it is available for transmission based on the PCH being in the idle state. Thus, in a case where the wireless communication apparatus 100 determines that it is unavailable for transmission as a result of performing carrier sense on the PCH, even if the other channels included in the same link are in the idle state, transmission may be deferred. Note that each of the channels other than the PCH that form one link may be referred to as a Secondary Channel (SCH). A SCH may also be referred to as a non-primary channel (NPCH).

In the IEEE 802.11 standard series, a function is specified that increases the communication speed by performing Multi User (MU) communication in which communication is simultaneously performed with multiplexing of radio resources between the AP 101 and the plurality of STAs 110. For example, the AP 101 may perform communication in parallel with the plurality of STAs 110 using OFDMA. OFDMA is an abbreviation for Orthogonal Frequency Division Multiple Access. In OFDMA, a plurality of units are formed on the frequency axis in a PPDU transmitted using a frequency channel of a predetermined bandwidth. Each of the plurality of units may be referred to as a Resource Unit (RU). The AP 101 allocates one or more different RUs to each STA 110. Multi User communication may be executed by the AP 101 performing communication with each of the STAs 110 in parallel using the RU allocated to each of the STAs 110. Note that the predetermined bandwidth may be 20 MHz, 40 MHz, 80 MHz, 160 MHz, 320 MHz, or the like. Also, each RU may be constituted by a plurality of subcarriers. For example, an RU constituted by 26 subcarriers is referred to as a 26-tone RU. Based on the number of subcarriers constituting the RU, the RU may be a 26-tone RU, a 52-tone RU, a 106-tone RU, a 242-tone RU, a 484-tone RU, a 996-tone RU, or the like.

Here, the bandwidth of the frequency band (operation frequency band) that the wireless communication apparatus 100 can use in communication may be different depending on the wireless communication apparatus 100. For example, if the operation frequency band of the AP 101 is 320 MHz, the bandwidth usable in communication by each of the STA 111 and the STA 112 is 80 MHz or less. In this case, according to matters specified in the current IEEE 802.11 standard series, the frequency band used in communication between the AP 101 and each of the STAs 110 is, of the 320 MHz band corresponding to the AP operation frequency band, a frequency band with a bandwidth of 80 MHz including the PCH. Note that the 80 MHz channel including the PCH may be referred to as the Primary 80 MHz Channel. Thus, in a case where the AP 101 communicates using OFDMA with the STA 111 and the STA 112, a plurality of RUs are formed in the 80 MHz frequency band of the Primary 80 MHz Channel and the RUs are allocated to each of the STAs 110. In this manner, even in a case where the operation frequency band of the AP 101 is 320 MHz, if the bandwidth that each of the STAs 110 can use is 80 MHz, the frequency band used between the AP 101 and the plurality of STAs 110 is restricted to the Primary 80 MHz Channel. This causes frequency resources not used in the operation frequency band of the AP 101 to exist, and the frequency resources not used are greater when the difference between the bandwidth usable by the AP 101 and the bandwidth usable by the STA 110 is greater.

### Overview of Dynamic Subband Operation

In light of such circumstances, Dynamic Subband Operation (DSO) is being looked into as a function for performing communication by changing the frequency band used by the STA 110 in the IEEE 802.11bn standard. DSO is a function for, in a case where there are many STAs connecting to an AP and collisions or the like are occurring in a first frequency band, effectively using the frequency band by performing communication using a second frequency band different from a first frequency band, from among the operation frequency bands from the AP. The first frequency band may be referred to as the primary band channel, and the second frequency band may be referred to as the secondary band channel. The AP 101 that can execute the DSO notifies the STA 110 of the switch to the second frequency band. The second frequency band may be referred to as a subband, a segment, a subblock, or the like. The STA 110 that can execute the DSO, in response to the notification from the AP 101, changes the used frequency band from the primary band channel to the secondary band channel. On the other hand, the STA 110 that cannot execute the DSO does not change the used frequency band from the primary band channel. Then, the STA 110 that can execute the DSO performs data communication with the AP 101 on the post-change secondary band channel. When data communication on the SCH is complete, the frequency band may be returned to the primary band channel. Note that the AP 101 can, in parallel, perform data communication with the STA 110 that can execute the DSO and perform data communication on the primary band channel with the other STA 110 that cannot execute the DSO. In this manner, the STA 110 that can execute the DSO, by switching to a frequency band to use in response to notification by the AP 101, can be made able to perform communication while effectively using the frequency resources in its operation frequency band. A configuration example of the STA 110 that operates in this manner and a processing example will be described below.

### Hardware Configuration

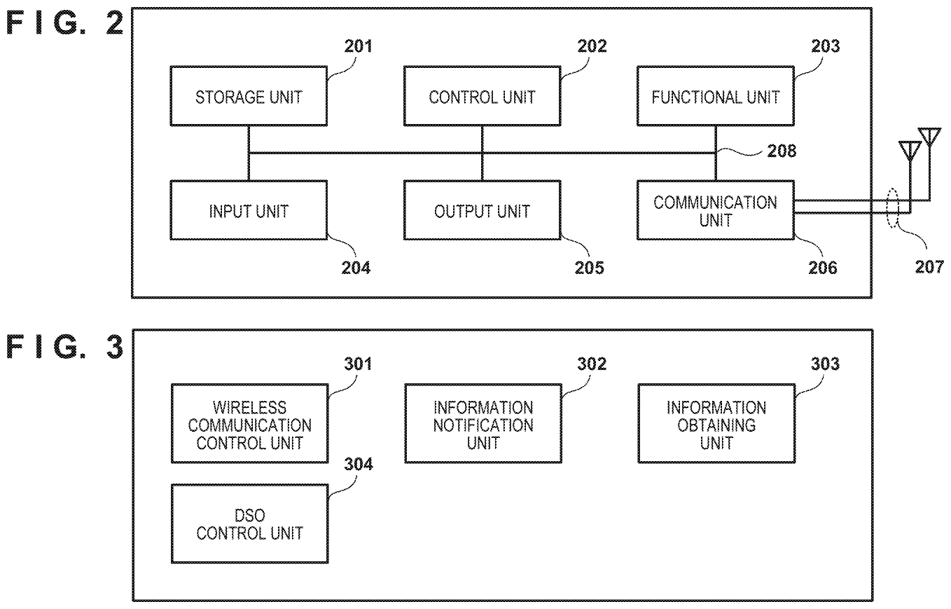

FIG. 2 illustrates an example of the hardware configuration of the STA 110 according to the present embodiment. The STA 110, as an example of the hardware configuration, includes a storage unit 201, a control unit 202, a functional unit 203, an input unit 204, an output unit 205, a communication unit 206, and an antenna 207. The storage unit 201, the control unit 202, the functional unit 203, the input unit 204, the output unit 205, the communication unit 206, and the antenna 207 are connected in a communication-enabling manner via a communication bus 208. The wireless communication apparatus 100 may include a plurality of antennas.

The storage unit 201 is constituted by one or more memories including a ROM, a RAM, or the like and may store various types of information including control programs for the functional units constituting the STA 110 to perform various types of operations, parameters for communication, and the like. ROM is an abbreviation for Read Only Memory, and RAM is an abbreviation for Random Access Memory. In addition to a memory such as the ROM and the RAM, the storage unit 201 may be configured to include a flexible disk, a hard disk, an optical disk, a magneto-optical disk, a CD-ROM, a CD-R, magnetic tape, a non-volatile memory card, a DVD, or a similar storage medium.

The control unit 202, for example, is constituted by one or more processors including a CPU, an MPU, or the like and controls the entire STA 110 by executing the control programs stored in the storage unit 201. Note that the control unit 202 may control the entire STA 110 via cooperation between a control program stored on the storage unit 201 and an Operating System (OS). Note that CPU is an abbreviation for Central Processing Unit, and MPU is an abbreviation for Micro Processing Unit. In a case where the control unit 202 includes a plurality of processors that may be implemented by multiple cores or the like, the control unit 202 may be configured in a manner such that the entire STA 110 is controlled by the plurality of processors.

Also, the control unit 202 controls the functional unit 203 and executes predetermined processing, such as communication, image capture, printing, projecting, and the like. The functional unit 203 is hardware for the STA 110 to execute predetermined processing described above. For example, in a case where the apparatus is a camera, the functional unit 203 is an image capture unit that executes image capture processing. Also, for example, in a case where the apparatus is a printer, the functional unit 203 is a printing unit that executes printing processing. In a case where the apparatus is a projector, the functional unit 203 is a projecting unit and executes projecting processing.

The input unit 204 receives various operations from a user. The output unit 205 outputs various types of output to a user via a monitor screen or a speaker, for example. In this example, output via the output unit 205 may correspond to displaying on a monitor screen, outputting audio via a speaker, outputting vibrations, and the like. Note that the input unit 204 and the output unit 205 may be implemented together as one module, such as in the case of a touch panel. Also, the input unit 204 and the output unit 205 may each be an apparatus integrally formed with the STA 110 or may each be separate apparatuses.

The communication unit 206 performs control of wireless communication compliant with the IEEE 802.11bn standard. Also, the communication unit 206 may perform control of wireless communication compliant with other legacy standards such as other IEEE 802.11 standard series in addition to the IEEE 802.11bn standard. The communication unit 206 controls the antenna 207 and transmits and receives signals for wireless communication generated by the control unit 202. The communication unit 206 is a so-called radio chip, and this may be provided with one or more processors and memories. Note that in a case where the wireless communication apparatus 100 supports NFC standards, Bluetooth standards, and similar wireless communication standards and wired LAN and similar wired communication in addition to the IEEE 802.11bn standard, the communication unit 206 may perform control of communication compliant with these communication standards. Also, in a case where the STA 110 can execute wireless communication that complies with a plurality of communication standards, the STA 110 may have a configuration in which a communication unit that supports each of the communication standards and an antenna are provided separately. The STA 110 communicates data with the partner wireless communication apparatus via the communication unit 206. Note that the antenna 207 may be separately formed from the communication unit 206 or may be formed as a single module together with the communication unit 206.

The antenna 207, for example, is an antenna that can communicate at the 2.4 GHz band, the 5 GHz band, the 6 GHz band, millimeter waves such as the 45 GHz band and the 60 GHz band, and the like. In FIG. 2, the illustrated configuration of the STA 110 includes the two antennas 207, but the STA 110 may include one or three or more antennas or may include one or more antennas for each frequency band usable by the apparatus. Also, in a case where the STA 110 includes a plurality of antennas, the STA 110 may include the communication unit 206 for each antenna.

### Functional Configuration

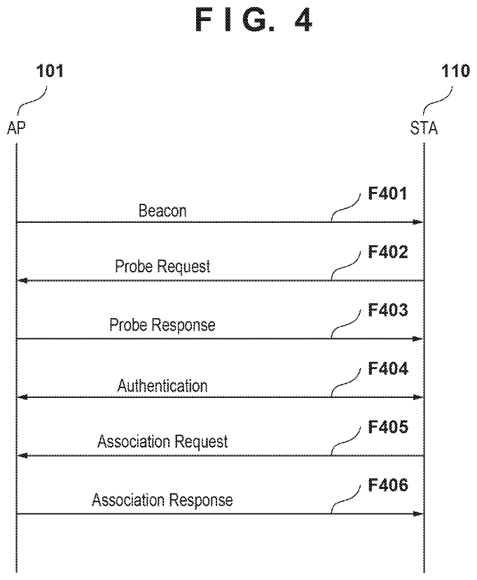

FIG. 3 illustrates an example of the functional configuration of the STA 110. The functional configuration according to the present embodiment, for example, is an example of a functional configuration implemented by the one or more processors executing programs stored in the one or more memories. The STA 110 may include a wireless communication control unit 301, an information notification unit 302, an information obtaining unit 303, and a DSO control unit 304.[0036] The wireless communication control unit 301 controls the communication with the AP 101. For example, the wireless communication control unit 301 may transmit and receive the frames required for performing communication via OFDMA with the AP 101. For example, the wireless communication control unit 301 may perform reception of UHR MU PPDUs and Trigger frames, transmission of UHR TB PPDUs, and the like. The wireless communication control unit 301 performs communication with the AP 101 using the frequency resources its apparatus is allocated with. Also, the wireless communication control unit 301 receives Beacon frames, Probe Response frames, and Association Response frames transmitted from the AP 101.[0037] The information notification unit 302 notifies the AP 101 of information relating to its apparatus. For example, the information notification unit 302 may notify the AP 101 of information that identifies whether or not its apparatus has the capability to perform communication using DSO. Also, the information notification unit 302 may notify the AP 101 of information indicating the movement amount that is possible on the frequency axis when its apparatus performs communication using DSO. Also, the information notification unit 302 may notify the AP 101 of information indicating the amount of time needed when its apparatus moves on the frequency axis.[0038] The information obtaining unit 303 obtains the information from the AP 101. The information obtaining unit 303 may obtain information that identifies whether or not the AP 101 has the capability to perform communication using DSO. Also, the information obtaining unit 303 may obtain information that identifies the delay time allowed by the AP 101 in communication using DSO. Also, the information obtaining unit 303 may obtain information that identifies the frequency resources allocated to its apparatus. The information that identifies the frequency resources obtained by the information obtaining unit 303 may be used by the wireless communication control unit 301, the DSO control unit 304, and the like.[0039] The DSO control unit 304 may give the wireless communication control unit 301 a DSO operation instruction based on the information received from the information obtaining unit 303. In other words, as described below, the DSO control unit 304 performs transmission control to control whether or not a wireless control frame requesting the start of DSO is transmitted. For example, the DSO control unit 304 sets the first frequency band including the PCH in the normal state as the frequency band to be used by its apparatus. In a case where the frequency resources allocated to its apparatus are included in a frequency band other than the first frequency band, the DSO control unit 304 sets a frequency band including the frequency resources as the frequency band to be used by its apparatus. Also, in a case where the DSO control unit 304 is notified of the need to move on the frequency axis from the AP 101, the DSO control unit 304 may change the frequency band to be used in the communication with the AP 101 in accordance with the notification. Also, when communication in the frequency band ends, the DSO control unit 304 returns the used frequency band to the first frequency band. Also, the DSO control unit 304 may transmit a request for the interference information of its apparatus and to start DSO control in the AP 101 to the AP 101 via the information notification unit 302. Also, the DSO control unit 304 controls whether or not to transmit a wireless control frame requesting the start of DSO to the AP 101. The interference information is information such as the band and time period in which interference is occurring, for example. Note that as the method of requesting the interference information and the start of DSO control, a Block Ack frame for the data received from the AP 101, a data frame to be transmitted to the AP 101, and an Action frame may be used, but the method is not limited thereto, and a different Control frame or Management frame may be used. Also, the request for the interference information and the start of DSO control may be included in the same wireless frame, and the interference information may be used as a request to start DSO control.[0040] Note that the functional configuration of the AP 101 is not the main focus of the present disclosure, and thus the description will be abbreviated.

### Processing Flow

Examples of the flow of processing executed by the STA 110 according to the present embodiment will be described below.

### Sharing Capability Information for Executing Communication Using DSO

The AP 101 and the STA 110 may share information relating to the capability of each communication apparatus to execute DSO when establishing a connection between the apparatuses. The operations executed in each communication apparatus when establishing a connection between the AP 101 and the STA 110 will now be described using FIG. 4. FIG. 4 illustrates a sequence example of processing executed when establishing a connection between the AP 101 and the STA 110. The sequence may be executed when the power of the STA 110 is turned on and a connection to the AP 101 is started, for example.

First, the AP 101 periodically transmits a Beacon frame (F401). The Beacon frame may include the capability information of the AP 101, communication parameters to be used in the BSS constituted by the AP 101, and the like. Capability information may be referred to as Capabilities information. Also, the communication parameter may be referred to as Operation information. The BSS constituted by the AP 101 may be referred to as its own BSS. For example, the AP 101 may transmit the operational bandwidth of the AP 101, the capability for executing DSO, and the like as its own capability information via a Beacon frame. Also, the AP 101 may transmit information that can identify the frequency band or the PCH used in its own BSS as a communication parameter and information that can identify whether the DSO is enabled or disabled via a Beacon frame. The STA 110 receives the Beacon frame transmitted by the AP 101. The STA 110 may identify the frequency band or the PCH being used by the AP 101, whether or not the AP 101 has the capability to use DSO, whether or not DSO is enabled, and the like using the received Beacon frame.

The STA 110 starts the association procedure by transmitting a Probe Request frame to the AP 101 based on the information obtained via the Beacon frame (F402). The Probe Request frame may include the capability information of the STA 110 and the communication parameters. For example, the STA 110 may transmit information indicating the operation frequency band of the STA 110, whether or not it has the capability to execute DSO, whether DSO is enabled or disabled, and the like as its own capability information via a Probe Request frame. For example, the STA 110 may notify the AP 101 that it has the capability to execute DSO using a UHR Capabilities element or UHR Operation element included in an Association Request frame.

Note that in a case where the AP 101 does not transmit a Beacon, a case where the STA 110 cannot appropriately receive the Beacon transmitted by the AP 101, and the like, the STA 110 may start the association procedure without receiving a Beacon. For example, the STA 110 may start the association procedure by transmitting a Probe Request frame using a Service Set Identifier (SSID) or the like registered in advance by the user or the like.

When the AP 101 receives the Probe Request frame, the AP 101 transmits a Probe Response frame (F403). The AP 101 may notify the STA 110 of its own capability information, the communication parameters to be used in its own BSS, and the like in the Probe Response frame. The AP 101 and the STA 110 perform authentication of each other as the partner wireless communication apparatus by exchanging an Authentication frame (F404).

When the authentication of the partner wireless communication apparatus is complete, the STA 110 transmits an Association Request frame (F405). The STA 110 may notify the AP 101 of its own capability information and communication parameters using the Association Request frame. When the AP 101 receives the Association Request frame, the AP 101 transmits an Association Response frame (F406). The AP 101 may notify the STA 110 of its own capability information and communication parameters of its own BSS using the Association Response frame. By receiving the Association Response frame from the AP 101, the STA 110 establishes a connection between the AP 101 and the STA 110 and ends the association procedure. Note that the AP 101 and the STA 110 may next execute a 4-way Handshake for sharing security information.

The AP 101 and the STA 110 may exchange information for executing DSO in the association procedure. For example, the AP 101 and the STA 110 may notify each other of information indicating whether or not they have the capability to execute DSO, and may obtain information indicating whether or not the partner wireless communication apparatus has the capability of executing DSO. The AP 101 becomes able to allocate to the STA 110 frequency resources included in the second frequency band different from the first frequency band set with the STA 110 based on the STA 110 having the capability to execute DSO. The STA 110 may start the exchange of information required to execute DSO between itself and the AP 101 based on identifying that the AP 101 has the capability to execute DSO. The AP 101 and the STA 110 may notify the other of information indicating that its function of executing DSO is enabled or disabled and may obtain information indicating whether or not the partner wireless communication apparatus has the function of executing DSO enabled or disabled. Even in a case where each of the wireless communication apparatuses 100 has the capability to execute DSO, the DSO function may be disabled due to interference in the surroundings or the like. By exchanging information indicating whether the DSO function is enabled, whether or not the wireless communication apparatus 100 and the partner wireless communication apparatus are in a state in which DSO can be executed can be identified. Note that in a case where a UHR Capabilities element is not included in the frame received from the partner wireless communication apparatus, the AP 101 and the STA 110 may determine that the partner wireless communication apparatus does not have the function to execute DSO. Accordingly, the AP 101 and the STA 110 can notify the partner wireless communication apparatus of whether or not they have the capability to execute DSO without needing to provide a field in a UHR Capabilities element for notifying of whether or not they have the function to execute DSO.

The AP 101 and the STA 110 may exchange information indicating the movement amount that is possible on the frequency axis when the STA 110 executes DSO. Accordingly, between the AP 101 and the STA 110, in the operation frequency band of the AP 101, a plurality of second frequency bands that can be used as the change destination can be set. For example, by obtaining the operation frequency band of the STA 110, the AP 101 may set a plurality of frequency bands in a range usable by the STA 110 in the frequency band used by the AP 101. For example, when the AP 101 operates at an operational bandwidth of 320 MHz, if the operational bandwidth of the STA 110 is 80 MHz, the AP 101 may set four frequency bands as the frequency bands usable with the STA 110. For the sake of description, they are named first to fourth subchannels in ascending order in terms of frequency.

Here, consider a case in which, if the AP 101 operates on the first subchannel with an 80 MHz-width including the PCH, the movement amount that is possible on the frequency axis of the STA 110 is 80 MHz. In such a case, the STA 110 can move to the second subchannel adjacent to the first subchannel but cannot move to the third and fourth subchannel that are not adjacent. In this case, the AP 101 sets two subchannels with a bandwidth of 80 MHz with the STA 110. In this manner, by the AP 101 and the STA 110 sharing information indicating the movement amount that is possible on the frequency axis when the STA 110 executes DSO, the frequency band can be set in a range that is settable as the frequency band used by the STA 110.

Also, the AP 101 and the STA 110 may exchange information indicating the amount of time required to switch the frequency when the STA 110 executes DSO. The amount of time required to switch the frequency when the STA 110 executes DSO may be referred to as a frequency switching delay. In this manner, in a case where the frequency switching delay of the STA 110 is greater than the amount of time that can be allowed by the AP 101 for the execution of DSO, the AP 101 may determine not to execute DSO with the STA 110. Also, in a case where the frequency switching delay of the STA 110 is greater than a predetermined amount of time, the AP 101 may execute control for assisting DSO by the STA 110. Note that the predetermined amount of time may be an amount of time set by a standard such as the Short Interframe Space (SIFS). For example, the AP 101 may adjust the length of the frame transmitted by the AP 101 as control for assisting the DSO by the STA 110. For example, the AP 101 may use the frequency switching delay of the STA 110 for determining the length of the frame when DSO is executed. For example, the AP 101 may add padding in accordance with the frequency switching delay of the STA 110 to the frame for notifying that the STA 110 is to be moved to another frequency band. The padding may be dummy data for adjusting the frame length. In this manner, the amount of time required for the STA 110 to move from the first frequency band including the PCH to the second frequency band different from the first frequency band may be ensured. Note that a first frequency switching delay in the case of the STA 110 moving from the first frequency band to the second frequency band may be different from a second frequency switching delay in the case of the STA 110 moving from the second frequency band to the first frequency band. In this case, the AP 101 may obtain the first frequency switching delay and the second frequency switching delay from the STA 110. Then, the AP 101 may add padding in accordance with both the case of the STA 110 moving from the first frequency band to the second frequency band and the case of the STA 110 moving from the second frequency band to the first frequency band. Note that the AP 101 may identify a frequency band for which at least one of the first frequency switching delay or the second frequency switching delay or both satisfy a predetermined threshold as the frequency band that the STA 110 can use for DSO. Also, in a case where the frequency switching delays are different due to the shift amount on the frequency axis of the STA 110, the AP 101 may obtain a frequency switching delay for each of the frequency bands. For example, the AP 101 may obtain each first frequency switching delay for the STA 110 to move to each of the second frequency band, the third frequency band, and the fourth frequency band using the first frequency band as a reference. Also, the AP 101 may obtain each second frequency switching delay for the STA 110 to move from the second frequency band, the third frequency band, and the fourth frequency band to the first frequency band. In this case, the AP 101 may add padding to a frame for notifying that the STA 110 is to be moved to another frequency band in accordance with the frequency switching delay corresponding to the frequency band in which the frequency resources allocated to the STA 110 are included.

The AP 101 may notify the STA 110 of the allowed amount of time that can be allowed as the frequency switching delay of the STA 110 in the case of the AP 101 executing DSO. The allowed amount of time may be notified via a Beacon frame or the like. When the STA 110 obtains the allowed amount of time, the STA 110 may determine whether or not its frequency switching delay is greater than the allowed amount of time of the AP 101. The STA 110 may disable DSO based on its frequency switching delay being greater than the allowed amount of time of the AP 101. In this case, the STA 110 may notify the AP 101 that it has disabled DSO. In this manner, information exchange for executing DSO between the AP 101 and the STA 110 can be skipped. Also, in a case where the frequency switching delays of the STA 110 are different due to the movement amount on the frequency axis, the STA 110 may notify the AP 101 of information indicating the movement amount that is possible within a range that does not exceed the allowed amount of time of the AP 101. In this manner, information exchange for executing DSO between the AP 101 and the STA 110 can be simplified.

The AP 101 may notify the STA 110 of its own capability information and communication parameters using a Beacon frame, a Probe Response frame, an Association Response frame, and the like. The STA 110 may notify the AP 101 of its own capability information and communication parameters using a Probe Request frame, an Association Request frame, and the like. The AP 101 and the STA 110 may voluntarily execute a notification of their own capability information and the like, or may execute a notification of their own capability information and the like based on a request by the partner communication apparatus. Also, the AP 101 and the STA 110 may passively obtain the capability information by waiting for notification of the capability information from the partner communication apparatus or may proactively obtain the capability information by requesting the partner communication apparatus for it. By broadcasting its capability information and the like using a Beacon frame, the AP 101 may efficiently notify an unspecified number of the STAs 110 of its capability information. Also, before the association procedure with the STA 110 is started, the STA 110 can reduce the amount of information to be exchanged in the association procedure by obtaining the capability information of the AP 101. Note that instead of a Beacon frame, a Fast Initial Link Setup (FILS) Discovery frame may be used. A FILS Discovery frame may be used for broadcasting only a portion (SSID, channel information, or the like) of the information included in a Beacon frame.

### Configuration of Capability Information for Executing DSO

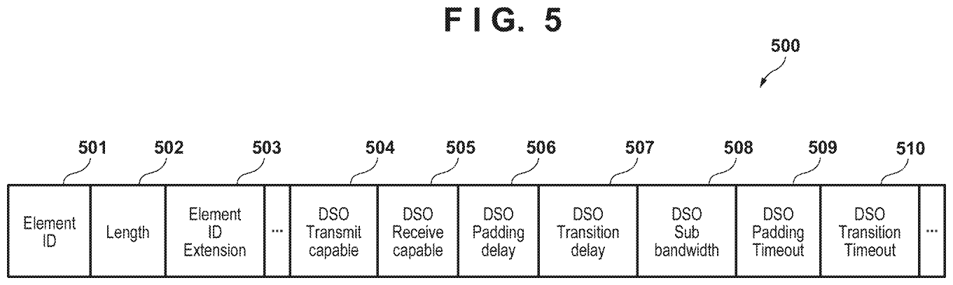

The configuration of information used when the wireless communication apparatus 100 notifies the partner communication apparatus of its own capability information relating to DSO will now be described. FIG. 5 illustrates a configuration example of an information element used when the wireless communication apparatus 100 notifies the partner wireless communication apparatus of its own capability information relating to DSO. An information element may be referred to as IE. The information element of FIG. 5 may be referred to as a UHR Capabilities element. The UHR Capabilities element may be included in a Beacon frame, a Probe Response frame, an Association Response frame, and the like. Also, the UHR Capabilities element may be included in a Probe Request frame, an Association Request frame, and the like. The UHR Capabilities element may be included in a frame other than these. For example, the UHR Capabilities element may be included in an Action frame. In this manner, after a connection is established between the AP 101 and the STA 110, the value for the frequency switching delay or the like can be changed in accordance with the surrounding situation, for example.

A UHR Capabilities element 500 includes an Element ID field 501, a Length field 502, and an Element ID Extension field 503. Also, the UHR Capabilities element may also include a DSO Transmit Capable (DTC) field 504 and a DSO Receive Capable (DRC) field 505. Also, the UHR Capabilities element may include a DSO Padding Delay field 506, a DSO Transition Delay field 507, and a DSO Subbandwidth field 508. The UHR Capabilities element may also include a DSO Padding Timeout field 509 and a DSO Transition Timeout field 510.

The Element ID field 501 indicates the type of information element in combination with the Element ID Extension field 503. For example, in a case where the Element ID field 501 is set to 255 and the Element ID Extension field 503 is set to 138, this indicates that the information element is a UHR Capabilities element. The Length field 502 indicates the length of the information element. The DTC field 504 indicates whether or not the wireless communication apparatus 100 has the capability to execute DSO transmission processing. Note that instead of the DTC field 504, a DSO UL Capable field may be included. The DSO UL Capable field indicates whether or not the wireless communication apparatus 100 has the capability to execute DSO uplink data processing. The DRC field 505 indicates whether or not the wireless communication apparatus 100 has the capability to execute DSO reception processing. Note that instead of the DRC field 505, a DSO DL Capable field may be included.

The DSO DL Capable field indicates whether or not the wireless communication apparatus 100 has the capability to execute DSO downlink data processing. Also, the DTC field 504 and the DRC field 505 may be configured as one field. In this case, the one field indicates whether or not the wireless communication apparatus 100 has the capability to execute DSO. In these fields, in a case where a value of 1 is set, this may indicate that the wireless communication apparatus 100 has the capability to execute DSO. In a case where a value of 0 is set, this may indicate that the wireless communication apparatus 100 does not have the capability to execute DSO. Note that the wireless communication apparatus 100 may implicitly indicate that DSO can be executed by transmitting a frame including the UHR Capabilities element. In this case, if the operation frequency band of the STA 110 is less than the operation frequency band of the AP 101, the STA 110 may be interpreted as being capable of DSO operation. For example, in a case where the operation frequency band of the AP 101 is 320 MHz, the wireless communication apparatus 100 that operates at a bandwidth of up to 160 MHz may be interpreted as being able to execute DSO. Note that the UHR Capabilities element may include, in addition to the DTC field 504 and the DRC field 505, a field indicating whether the wireless communication apparatus 100 has DSO enabled or disabled. Also, this field may be included in an information element other than the UHR Capabilities element. For example, this field may be included in a UHR Operation element.

The DSO Padding Delay field 506 to the DSO Subbandwidth field 508 may be included in the frame transmitted by the STA 110. Also, the DSO Padding Timeout field 509 and the DSO Transition Timeout field 510 may be included in the frame transmitted by the AP 101. Note that in a case where the DSO Padding Delay field 506 to the DSO Subbandwidth field 508 are included in the frame transmitted by the AP 101, these fields may be treated as reserved areas. Also, in a case where the DSO Padding Timeout field 509 and the DSO Transition Timeout field 510 are included in the frame transmitted by the STA 110, these fields may be treated as reserved areas. The fields described above may be fields that exist in a case where a value of 1 is set in the DTC field 504 or the DRC field 505, that is, in a case where the wireless communication apparatus 100 has the capability to execute DSO.

The DSO Padding Delay field 506 indicates the amount of time (frequency switching delay) required to switch the frequency when the STA 110 executes DSO. For example, the DSO Padding Delay field 506 may indicate the first frequency switching delay required for the STA 110 to move from the first frequency band included in the operation frequency band of the AP 101 to the second frequency band. The first frequency switching delay may be the amount of time required from when the STA 110 has finished receiving the User Info field allocated to the STA 110 in the Trigger frame to when the STA 110 enters a state in which communication can be performed using the other frequency band. A configuration example of the DSO Padding Delay field 506 is indicated in Table 1. Table 1 indicates the values set for the DSO Padding Delay field 506 and the amount of time corresponding to the values in a case where the DSO Padding Delay field 506 is made up of 3 bits. For example, in a case where the DSO Padding Delay field 506 is included in the UHR Capabilities element received from the STA 110, the AP 101 may identify the first frequency switching delay of the STA 110 based on Table 1. Note that in a case where the first frequency switching delay differs depending on the movement amount of the STA 110 on the frequency axis, the DSO Padding Delay field 506 may be provided corresponding to each of the movement amounts.

TABLE 1

| DSO Padding Delay field value | DSO Padding delay | |
|---|---|---|
| 0 | 0 | μsec |
| 1 | 32 | μsec |
| 2 | 64 | μsec |
| 3 | 128 | μsec |
| 4 | 256 | μsec |
| 5 | 512 | μsec |
| 6 | 1 | TU |
| 7 | 2 | TUs |

The DSO Transition Delay field 507 indicates information indicating the amount of time (frequency switching delay) required to switch the frequency used in communication when the STA 110 executes DSO. For example, the DSO Transition Delay field 507 may indicate the second frequency switching delay required for the STA 110 to move from another frequency band to the first frequency band. A configuration example of the DSO Transition Delay field 507 is indicated in Table 2. Table 2 indicates the values set for the DSO Transition Delay field 507 and the amount of time corresponding to the values in a case where the DSO Transition Delay field 507 is made up of 3 bits. For example, in a case where the DSO Transition Delay field 507 is included in the UHR Capabilities element received from the STA 110, the AP 101 may identify the second frequency switching delay of the STA 110 based on Table 2. Note that in a case where the second frequency switching delay differs depending on the movement amount that the STA 110 moves on the frequency axis, the DSO Transition Delay field 507 may be provided corresponding to each of the movement amounts.

TABLE 2

| DSO Transition Delay field value | DSO transition delay | |
|---|---|---|
| 0 | 0 | μsec |
| 1 | 16 | μsec |
| 2 | 32 | μsec |
| 3 | 64 | μsec |
| 4 | 128 | μsec |
| 5 | 256 | μsec |
| 6 | 512 | μsec |
| 7 | 1 | TU |

The DSO Subbandwidth field 508 indicates information indicating the frequency range (movement amount) possible on the frequency axis when the STA 110 executes DSO. The possible movement amount may be the movement amount possible on the frequency axis when the STA 110 transitions from a state of communicating using a predetermined frequency band to a state of communicating using another frequency band. Also, the possible movement amount may be the frequency range in which movement is possible on the frequency axis for changing the frequency band used by the STA 110 within a range in accordance with the allowed amount of time for the AP 101 to execute DSO. A configuration example of the DSO Subbandwidth field 508 is indicated in Table 3. Table 3 indicates values set for the DSO Subbandwidth field 508 and frequencies corresponding to the values in a case where the DSO Subbandwidth field 508 is made up of 3 bits. For example, in a case where the DSO Subbandwidth field 508 is included in the UHR Capabilities element received from the STA 110, the AP 101 may identify the frequency range in which the STA 110 can move based on Table 3. Consider an example in which the DSO Subbandwidth field 508 is set with a value of 3 and the frequency bandwidth usable by the STA 110 is set to 80 MHz. This case may indicate that the STA 110 can switch the used frequency range in a range of 80 MHz from the first frequency band with a bandwidth of 80 MHz. For example, this may indicate that the STA 110 can use the first frequency band with a bandwidth of 80 MHz and the adjacent second frequency band. Note that the movable frequency range may indicate the frequency bandwidth that the STA 110 becomes able to use when DSO is executed. For example, a case with the operation frequency band of the STA 110 set to 80 MHz and a value of 4 set for the DSO Subbandwidth field 508 indicates that a 160 MHz-bandwidth can be used. This indicates that, a result of the STA 110 that can use a bandwidth of 80 MHz becoming able to move 80 MHz in bandwidth via DSO, the range of the band that the STA 110 can use in communication has been increased to 160 MHz.

Note that the DTC field 504, the DRC field 505, and the DSO Subbandwidth field 508 may be configured as one field. In this case, if the field is set with a value of 0, this may indicate that the wireless communication apparatus 100 cannot execute DSO. Also, if the field is set with a value other than 0, this may indicate that the wireless communication apparatus 100 can execute DSO. On the other hand, in a case where the DSO Subbandwidth field 508 is independent from the DTC field 504 and the like, a value of 0 for the DSO Subbandwidth field may be associated with a DSO Subbandwidth of 20 MHz. In this case, the DSO Subbandwidth increases in correspondence with each of the values of the DSO Subbandwidth field. For example, a value of 1 for the DSO Subbandwidth field is associated with a DSO Subbandwidth of 40 MHz.

TABLE 3

| DSO Subbandwidth field value | DSO Subbandwidth | |
|---|---|---|
| 0 | Reserved | |
| 1 | 20 | MHz |
| 2 | 40 | MHz |
| 3 | 80 | MHz |
| 4 | 160 | MHz |
| 5 | 320 | MHz |

| | |
|---|---|
| 6 | Reserved |
| 7 | Reserved |

The DSO Padding Timeout field 509 indicates the allowed amount of time that can be allowed as the frequency switching delay of the STA 110 in the case of the AP 101 executing DSO. For example, the DSO Padding Timeout field 509 may indicate the allowed amount of time for the first frequency switching delay required for the STA 110 to move from the first frequency band to another frequency band. A configuration example of the DSO Padding Timeout field 509 is indicated in Table 4. Table 4 indicates the values set for the DSO Padding Timeout field 509 and the amount of time corresponding to the values in a case where the DSO Padding Timeout field 509 is made up of 4 bits. For example, in a case where the DSO Padding Timeout field 509 is included in the UHR Capabilities element received from the AP 101, the STA 110 may identify the amount of time allowed for the first frequency switching delay based on Table 4. Note that in a case where the allowed amount of time for the first frequency switching delay is different depending on the frequency range of movement of the STA 110 on the frequency axis, the DSO Padding Timeout field 509 may be provided corresponding to each of the frequency ranges.

TABLE 4

| DSO Padding Timeout/DSO | DSO Padding Timeout/ | |
|---|---|---|
| Transition Timeout field value | DSO Transition Timeout | |
| 0 | 0 | μsec |
| 1 | 128 | μsec |
| 2 | 256 | μsec |
| 3 | 512 | μsec |
| 4 | 1 | TU |
| 5 | 2 | TUs |
| 6 | 4 | TUs |
| 7 | 8 | TUs |
| 8 | 16 | TUs |
| 9 | 32 | TUs |
| 10 | 64 | TUs |

| | |
|---|---|
| 11-15 | Reserved |

The DSO Transition Timeout field 510 indicates the allowed amount of time that can be allowed as the frequency switching delay of the STA 110 in the case of the AP 101 executing DSO. For example, the DSO Transition Timeout field 510 may indicate the allowed amount of time for the second frequency switching delay required for the STA 110 to move from another frequency band to the first frequency band. The DSO Transition Timeout field 510 may be configured in a similar manner to the DSO Padding Timeout field 509 as indicated in Table 4, for example.

Note that the associations with each of the values in Tables 1 to 4 described above are examples, and they may be associated differently. For example, Tables 1 to 4 indicate an example in which each time the field value increases by 1, the corresponding value exponentially increases. However, the values may be set in such a manner that each time the field value increases by 1, the corresponding value increases by only the same value. For example, in Table 1, the value for the DSO Padding Delay field 506 may increase by 16 usec each time. Also, in Tables 1, 2, and 4, different values are associated with the same values set in the fields, but the same values may be associated. For example, in a case where the value for the DSO Padding Delay field in Table 1 is 1, 16 usec may be associated with this value in a similar manner to Table 2 in the case of the value for the DSO Padding Delay field being 1. Also, Tables 1 to 3 indicate examples in which each field is configured by 3 bits. However, each of these fields may be made up of 1, 2, or 4 or more bits. In a similar manner, Table 4 indicates an example in which the fields are made up of 4 bits, but the fields may be made up of 1 to 3 or 5 or more bits. Also, the DSO Padding Delay field 506 and the DSO Transition Delay field 507 may be configured as one field. In a similar manner, the DSO Padding Timeout field 509 and the DSO Transition Timeout field 510 may be configured as one field. For example, in a case where the first frequency switching delay and the second frequency switching delay are approximately the same, by configuring these fields as one field, the amount of information communicated can be reduced.

Fields other than the fields included in FIG. 5 may be included in the UHR Capabilities element. For example, a predetermined field indicating information for identifying each frequency band set in the frequency band used by the AP 101 may be included. For example, the STA 110 may notify the AP 101 of information indicating information indicating the number of frequency bands to be set in the operation frequency band of the AP, information indicating the number of frequency switching positions, and the like using a predetermined field. In a case where the number of frequency bands is indicated by a predetermined field, the frequency bands with the same bandwidth as the bandwidth that the STA 110 can use may be set to the same number as the number of frequency bands indicated by the predetermined field. Also, in a case where the number of frequency bands is indicated by a predetermined field, frequency bands of the number indicated by the predetermined field may be set in the frequency band used by the AP 101. In this case, the bandwidth of each frequency band may be identified by dividing the bandwidth of the frequency band used by the AP 101 by the set number of frequency bands. Also, in a case where the number of frequency switching positions is indicated by a predetermined field, frequency switching positions of the number indicated by the predetermined field may be set for each bandwidth usable by the STA 110 in the frequency band used by the AP 101. Also, in a case where the number of frequency switching positions is indicated by a predetermined field, the frequency switching positions may be set at positions on the frequency axis obtained by dividing the frequency band used by the AP 101 by the number indicated by the predetermined field. Note that the AP 101 may determine a plurality of frequency bands and frequency switching positions to set in the frequency band it uses based on the predetermined field described above included in a frame received from the STA 110. Then, the AP 101 may notify the STA 110 of the result in the predetermined field described above in a frame transmitted by the AP 101. Note that the AP 101 may unilaterally determine the plurality of frequency bands and frequency switching positions set in the frequency band used by the AP 101 and notify the STA 110 of this.

FIG. 5 illustrates an example in which a UHR Capabilities element is used for the wireless communication apparatus 100 to notify the partner communication apparatus of its capability information for executing DSO. However, the capability information notification may be performed using another information element. For example, an Extended Capabilities element for extending the UHR Capabilities element, a Multi-Link element for notifying of information relating to Multi-Link communication, or the like may be used. Also, a novel element (DSO element or the like) for exchanging capability information relating to DSO of a communication apparatus or the like may be defined.

### DSO Control Processing by STA

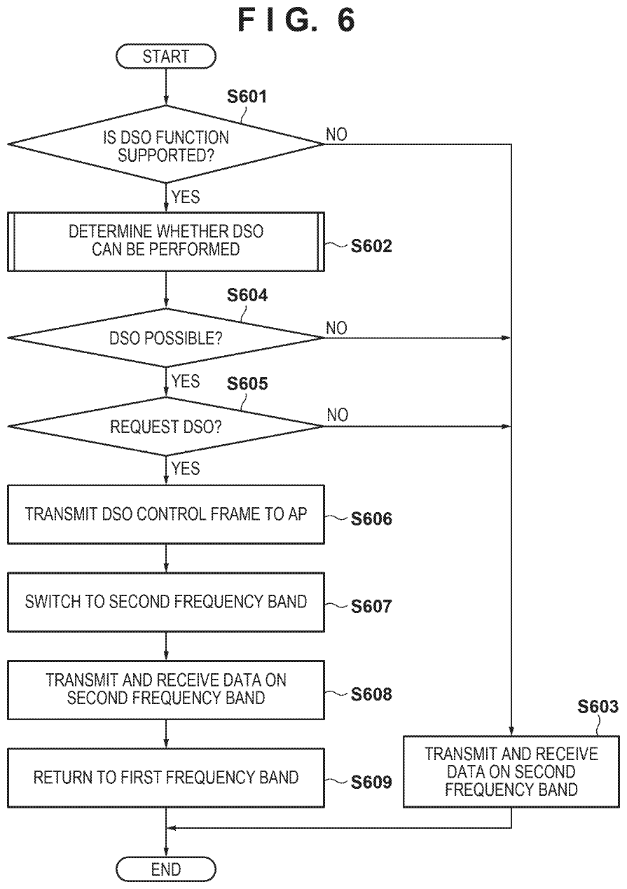

Next, processing by the STA 110 to transmit a request to start DSO to the AP 101 will be described. FIG. 6 illustrates a flowchart indicating processing executed by the STA 110 in the case of transmitting a request to start DSO to the AP 101. Note that the sequence of FIG. 6 may be executed after a connection has been established between the AP 101 and the STA 110 as illustrated in FIG. 4. Also, each step of FIG. 6 is implemented by the control unit 202 reading out and executing a program stored in the storage unit 201.

First, the control unit 202 determines whether or not the DSO function is supported (S601). In this determination, in a case where both the STA 110 and the AP 101 support the DSO function, the control unit 202 can determine that the DSO function is supported, and in a case where at least one of the STA 110 and the AP 101 does not support the DSO function, the control unit 202 can determine that the DSO function is not supported. Note that the DSO function support state of the AP 101 can be determined by the method described using FIGS. 4 and 5.

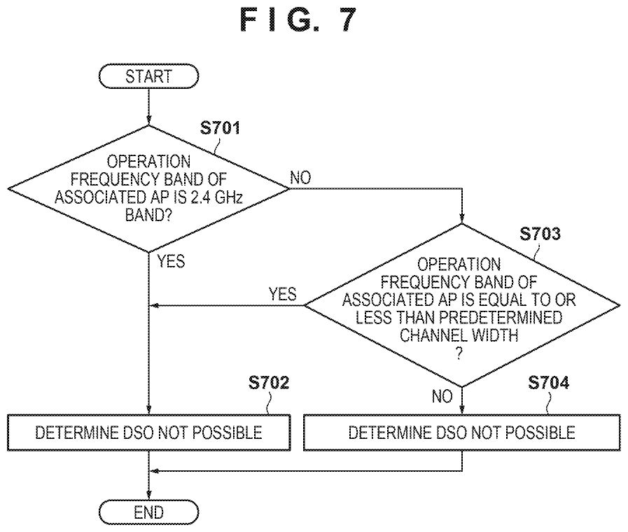

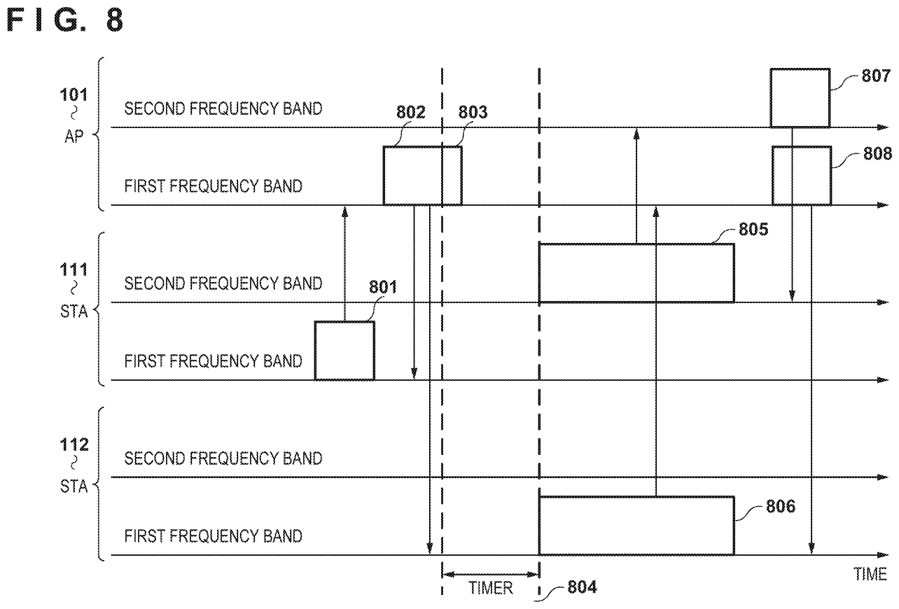

In a case where, as the result of the determination of step S601, it is determined that the DSO function is supported (YES in step S601), the control unit 202 determines whether or not DSO can be performed based on the operation channel of the AP 101 and the communication environment (S602). Note that this determination can be executed at any timing, and may be executed in response to a notification from the AP 101, can be executed in response to a change in the communication environment such as the interference status, and can be executed periodically at a predetermined cycle. This processing will be described below in detail using FIG. 7.

In a case where, as a result of the determination of step S601, it is determined that the DSO function is not supported (NO in step S601), the control unit 202 transmits and receives data with the AP 101 using the current first frequency band without performing control via DSO and ends the processing (S603).

### Processing to Determine Whether DSO can be Performed Based on Associated AP Operation Channel

FIG. 7 is a flowchart illustrating the processing executed in the case of determining whether or not the STA 110 with a DSO function can start DSO based on the operation channel of the AP 101.

Whether or not the AP 101 is operating on the 2.4 GHz band channel is determined (S701). Information relating to the operation frequency band of the AP 101 may be included in a Beacon frame periodically transmitted by the AP 101, a Probe Response frame transmitted by the AP 101 when the STA 110 establishes a connection with the AP 101, an Association Response frame, or the like. Thus, the STA 110 can receive this information and determine whether or not the AP 101 is operating on the 2.4 GHz band channel.

In a case where, as the result of determination in step S701, it is determined that the AP 101 is operating on the 2.4 GHz band channel (YES in step S701), it is determined that DSO cannot be performed (S702). Typically, the 2.4 GHz band is congested compared to other bands such as the 5 GHz band, and interference tends to occur due to it being shared by microwave ovens, other Bluetooth devices, and the like. Thus, there is a high possibility of interference even if the second frequency band different from the first frequency band is switched to in the operation frequency band of the AP 101. Thus, when the STA 110 performs DSO control, there is a high possibility that it will be for nothing. Also, here, a flag relating to whether or not DSO can be performed may be set to “DSO not possible”. In step S604 described below, whether or not DSO can be performed can be determined by referencing the flag set in the present step.

In a case where, as the result of determination in step S701, it is determined that the AP 101 is operating on a band other than the 2.4 GHz band such as the 5 GHz band or the 6 GHz band (NO in step S701), whether or not the operation channel width of the associated AP 101 is equal to or less than a predetermined channel width is determined (S703). Note that in the determination of S701, it is sufficient that the operation frequency band of the AP 101 includes a frequency band other than the 2.4 GHz band. In other words, in a case where a frequency band other than the 2.4 GHz band is selectable as the movement destination of the communication between the AP 101 and the STA 110, the processing may advance to S703. Accordingly, in a case where the AP 101 has an operation frequency band that includes the 2.4 GHz band, the STA 110 can transmit a request to start DSO to the AP 101.

The predetermined channel width in the processing of S703, for example, is the 20 MHz that is used as the basic channel width in the IEEE 802.11 standards, for example. Information relating to the operation channel width of the AP 101 may be included in the above-described Beacon frame, Probe Response frame, Association Response frame, or the like. Thus, the STA 110 can receive this information and determine whether or not the operation channel width of the AP 101 is equal to or less than a predetermined channel width. Also, with this configuration, the determination of step S702 is performed after step S701, but the determination of step S702 may be performed before step S701.

In a case where, as the result of determination in step S703, it is determined that the operation channel width of the AP 101 is equal to or less than the predetermined channel width (YES in step S703), the processing moves to step S702 and it is determined that DSO cannot be performed. For example, in a case where the operation channel width of the AP 101 is equal to or less than 20 MHz, the operation frequency band of the AP 101 is only the first frequency band used in communication with the STA 110 and a switch to other frequency bands cannot be performed. In this case, since the STA 110 transmitting a request to start DSO would be for nothing, the STA 110 may determine that DSO cannot be performed.

In a case where, as the result of determination in step S703, it is determined that the operation channel width of the AP 101 is greater than the predetermined channel width (NO in step S703), it is determined that DSO can be performed (S704). In a case where the operation channel width of the AP 101 is either 40 MHz, 80 MHz, 160 MHz, or 320 MHz, it is determined that DSO can be performed since the second frequency band different from the first frequency band used in communication between the AP 101 and the STA 110 can be switched to. Note that here, a flag relating to whether or not DSO can be performed may be set to “DSO possible”. In step S604 described below, whether or not DSO can be performed can be determined by referencing the flag set in the present step.

As a result of the processing of the flowchart illustrated in FIG. 7, the STA 110 with the DSO function can determine whether or not DSO can be performed based on the frequency band and/or frequency range of the operation channel of the associated AP 101.

The description will now return to FIG. 6. The control unit 202 determines whether or not DSO is possible based on the determination of step S602 (S604). Here, for example, the control unit 202 can determine whether or not DSO can be performed by referencing the value of the flag relating to whether or not DSO can be performed set in step S702 or step S704 described above.

In a case where, as the result of step S604, it is determined that DSO is not possible (NO in step S604), the control unit 202 moves the processing to step S603 described above, uses the first frequency band to transmit and receive data with the AP 101, and ends the processing.

On the other hand, in a case where, as the result of step S604, it is determined that DSO is possible (YES in step S604), the control unit 202 further determines whether or not to request DSO (S605).

For example, the STA 110 may be provided with an interference detection unit (not illustrated) that detects the strength of signals transmitted from outside of the network 121 as interference via the communication unit 206 for at least one of the first frequency band and the second frequency band different from the first frequency band. Also, via the interference detection unit, for example, the STA 110 can identify the interference intensity for the second frequency band as a candidate for the movement destination from the first frequency band. Accordingly, in a case where the interference intensity of the second frequency band is less than a predetermined threshold, the STA 110 can request the start of DSO since the movement destination communication environment is good. On the other hand, in a case where the interference intensity is equal to or greater than the predetermined threshold, the STA 110 can determine that the movement destination communication environment is not good and perform control so that a wireless control frame requesting the start of DSO is not transmitted.

Note that a determination based on interference intensity may take into account the interference intensity of the first frequency band including the primary channel. For example, in a case where there is interference in at least a portion of the first frequency band of the STA 110, the STA 110 may request the start of DSO, and in a case where there is no interference, the STA 110 may determine not to request the start of DSO. In this manner, the STA 110 can request the AP 101 to switch to another frequency band in a case where the interference intensity in the first frequency band is high.

Also, in the case of taking into account the interference intensity of both the first and second frequency band, if there is interference in the first frequency band but no interference in the second frequency band, the start of DSO can be requested so that communication is performed using the second frequency band. The interference may be periodic or aperiodic and may be able to be predicted in advance or difficult to predict. Note that the interference expected may be from Bluetooth (BT) signals when the STA simultaneously uses a wireless LAN and BT, transmitting and receiving of the fifth generation mobile communication system (5G) New Radio (NR) signals or the like, external noise, and the like. Also, with this configuration, the determination of step S605 is performed after step S604, but the determination may be performed before step S604.

Note that in a case where there is interference in the entire second frequency band different from the first frequency band, it may be determined not to request the start of DSO, and in a case where there is interference in a portion of the second frequency band, it may be determined not to request the start of DSO. For example, in a case where there are a plurality of the second frequency band that exist in the operation frequency band of the AP 101 as movement destinations from the first frequency band, if there is interference in all of the second frequency bands, a request to start DSO may not be performed. Alternatively, in a case where there is interference in one or more of any of the plurality of second frequency bands, a request to start DSO may not be performed.

Also, the STA 110 may include a value indicating the interference intensity detected by the interference detection unit in the wireless control frame for requesting the start of DSO and may include a value indicating the interference intensity in a wireless frame different from the wireless control frame for requesting the start of DSO. In this case, the wireless control frame may include at least one of the interference intensity for the first frequency band including the primary channel and the interference intensity for the second frequency band. Also, in a case where a plurality of the second frequency band exist in the operation frequency band of the AP 101, the value indicating the interference intensity may be included in the wireless control frame associated together with the identifiers of the plurality of second frequency bands. Also, only the identifiers of the frequency bands with an interference intensity of less than a predetermined threshold from among the plurality of second frequency bands may be transmitted to the AP 101.

Note that the processing of S605 is processing for controlling whether or not to transmit a request to start DSO depending on the communication environment, and this may be omitted. In this case, as described above in S602, whether or not a request to start DSO is transmitted is controlled in accordance with the operation status of at least one of the AP 101 and the STA 110.

In a case where, as the result of step S605, it is determined to not request DSO (NO in step S605), the STA 110 moves the processing to step S603, uses the first frequency band to transmit and receive data with the associated AP 101, and ends the processing.

On the other hand, in a case where, as the result of step S605, it is determined to request DSO (YES in step S605), the STA 110 transmits a wireless control frame for requesting the start of DSO to the AP 101 (S606). Note that in a case where the STA 110 obtains a Transmission Opportunity (TXOP), the transmission of the wireless control frame here may be performed during a TXOP time period. Also, in a case where the AP 101 obtains a TXOP, the transmission of the wireless control frame may be performed as a response to data received from the AP 101. Note that the method for requesting the start of DSO is as already described using FIG. 4 and thus will not be described here.

Next, the STA 110 switches the frequency band being used from the first frequency band to the second frequency band (S607) and transmits and receives data with the AP 101 using the second frequency band switched to (S608). Note that the AP 101 performs communication with the STA 110 allocated to the second frequency band with no interference based on the DSO start request or interference information received from the STA 110 with the DSO function. Also, the AP 101 may start data communication after the frequency switching delay time of the STA 110 based on the DSO Padding Delay field 506 described above.

When the transmitting and receiving of data in step S608 ends, the frequency band being used is returned to the first frequency band (S609), and the processing ends.

Note that in the present embodiment, a method in which communication is performed by the STA 110 using a single link has been described. However, the AP 101 and the STA 110 may be AP MLDs or STA MLDs that support Multi-Link, the STA 110 may include a number of antennas equal to the number of supporting links, and the communication unit 206 may be provided for each antenna. In this case, the STA 110 may execute the sequence of step S601 to step S609 for all of the links or a portion of the links to perform communication simultaneously using different links of the communication band.

As a result of the processing of the flowchart illustrated in FIG. 6, the STA 110 with the DSO function can transmit a request to start DSO to the associated AP.

### Uplink Direction Data Communication Processing Between AP and STA

FIG. 8 illustrates a sequence example in a case where the STA 110 performs uplink direction communication (uplink communication) to transmit data to the AP 101. Note that in this communication, OFDMA is used. For example, each of the STAs 110 transmits data using a UHR TB PPDU that supports OFDMA. UHR TB PPDU is an abbreviation for an Ultra High Reliability Trigger-based PPDU. In this example, the AP 101 and the STA 111 support the DSO function, and the STA 112 does not support the DSO function. Also, the AP 101 and the STA 110 have already established a connection. In this example, in the connection between the AP 101 and the STA 111, two 160 MHz-bandwidth frequency bands for executing DSO are set in the frequency band used by the AP 101.[0096] The STA 111 transmits a request 801 for starting DSO in the first frequency band. For example, the STA 111 can use a Block Ack frame as the request 801. However, no such limitation is intended, and the STA 111 may transmit an Action frame or a Management frame. Also, the request 801 may include information relating to the interference status of the STA 111 in the first frequency band and the second frequency band. Also, the transmission of information relating to the interference status may be treated as information for the STA 110 to request the start of DSO.[0097] Also, in this example, the STA 111 and the STA 112 accumulate data, and the AP 101 obtains information relating to each of the STAs 110 accumulating data. Since the AP 101 causes this data to be transmitted, the frequency resources of the first frequency band are allocated to the STA 112 that cannot perform DSO and the frequency resources of the second frequency band are allocated to the STA 111 that can perform DSO.[0098] The AP 101, before transmission of data by the STA 110, transmits a notification 802 to make the STA 111 move to the second frequency band. For example, the AP 101 may transmit a Trigger frame as the notification 802. The Trigger frame may be a Basic type of Trigger frame. The AP 101 transmits a Trigger frame in the first frequency band including the PCH so that both the STA 111 and the STA 112 can receive it. The Trigger frame may include a User Info field corresponding to each of the STA 111 and the STA 112. The User Info field may include information indicating the frequency resources allocated to the corresponding STA 110. For example, the AP 101 may notify of information indicating the allocation of frequency resources of the second frequency band using the User Info field corresponding to the STA 111 to implicitly instruct the STA 111 to move to the second frequency band. Also, the AP 101 may use the User Info field corresponding to each of the STAs 110 to notify of the frequency resources (RU) allocated to each. In this manner, the AP 101, with one notification, can instruct the STA 111 to move to the second frequency band and notify of the frequency resources allocated to each of the STAs 110. Note that the AP 101 may perform a notification to instruct the STA 111 to move to the second frequency band and to notify of the frequency resources allocated to each of the STAs 110 via different information or a different frame. For example, in a Trigger frame, a field for instructing to move the frequency band may be newly specified, or a new frame for instructing to move the frequency band may be specified. In this manner, the AP 101 can explicitly notify the STA 111 to move to the second frequency band. Note that the AP 101 may add padding 803 to the frame used for the notification 802. The padding 803 may be added based on the frequency switching delay for the STA 111 moving to the second frequency band. When the STA 111 receives the notification 802, the STA 111 moves to the second frequency band. For example, in a case where the notification 802 is a Basic type of Trigger frame, the STA 111 may identify that frequency resources of the second frequency band have been allocated to the STA 111 from the information included in the User Info field associated with the STA 111. In this case, the STA 111 may identify that the STA 111 is to move to the second frequency band based on the frequency resources of the second frequency band being allocated to the STA 111. After the STA 111 moves to the second frequency band, the STA 111 transmits data 805 using the frequency resources allocated to the STA 111. Note that in a case where the amount of time taken from when the movement to the second frequency band starts to when the STA 111 is in a data-transmittable state is equal to or less than the allowed amount of time notified by the AP 101, the STA 111 may transmit the data 805. In this case, when reception of the User Info field associated with the STA 111 is complete, the STA 111 both starts moving to the second frequency band and activates a timer 804. The timer 804 may be set to expire in the allowed amount of time notified by the AP 101. When the STA 111 transmits the data 805, if the timer 804 has not expired, the STA 111 transmits the data 805. If the timer 804 has expired, the STA 111 does not transmit the data 805. This can prevent the STA 111 from transmitting the data 805 at a timing after the amount of time allowable by the AP 101.[0100] When the STA 112 receives the notification 802, the STA 112 transmits data 806 using the first frequency band. For example, in a case where the notification 802 is a Basic type Trigger frame, the STA 112 transmits the data 806 using the frequency resources allocated in the User Info field corresponding to the STA 112 of the Trigger frame.[0101] When the AP 101 receives the data from each of the STAs 110, the AP 101 performs acknowledgement. For example, the AP 101 may perform acknowledgement by transmitting a Block Ack frame. The AP 101 transmits a Block Ack frame 807 using the second frequency band in response to the data 805 received from the STA 111 via the second frequency band. Also, the AP 101 transmits a Block Ack frame 808 using the first frequency band in response to the data 806 received from the STA 112 via the first frequency band. The STA 110 ends the transmission processing when it receives an acknowledgement to the data it transmitted. Note that when the reception of the Block Ack 807 for the data 805 is complete, the STA 111 moves to the first frequency band.[0102] As described above, according to the present embodiment, control is performed for whether or not a STA transmits a DSO start request to an AP in accordance with the frequency band and frequency range of the AP operation channel, which allows the STA to be prevented from transmitting information not required to start DSO for nothing.[0103] Note that in the present embodiment, an example has been described in which the operation of performing communication while dynamically switching to a second frequency different from a first frequency band including the PCH is referred to as DSO. However, no such limitation is intended, and this may be referred to by another name. In the present embodiment, an example has been described in which the frequency band including the PCH is referred to as the first frequency band, and the frequency band not including the PCH is referred to as the second frequency band and the like. However, no such limitation is intended, and these may be referred to by different names. Also, in the present embodiment, parameters referred to as the frequency switching delay, the frequency switching position, and the like may be referred to by different names. Similarly, the fields and subfields included in the configuration example of FIG. 5 may be referred to by different names. The values corresponding to the setting values of the information indicated in Tables 1 to 4 may be configured differently.

### Modification Example

In the present embodiment described above, whether or not to start DSO is determined based on information of the frequency band that a partner apparatus is operating on and information relating to the operating frequency width. However, it is sufficient that whether or not to start DSO is determined based on at least one or more of the operation status of the partner apparatus and the communication environment.

For example, the STA 110 may include a detection unit that detects access points via an Overlapping Basic Service Set (OBSS) Scan. The detection unit can, together with detecting APs in the surroundings, determine whether or not the operation mode of detected APs supports the 40 MHz channel mode for communication using the 40 MHz band via an OBSS Scan. In a case where an AP that does not support the 40 MHz channel mode is detected, the STA 110 transmits a 20/40 BSS Coexistence Management frame and notifies the associated AP of the OBSS. Then, the associated AP may switch the operation frequency band to 20 MHz.

In this case, if an AP that does not support the 40 MHz channel mode is detected, the STA 110 may determine not to transmit a request to start DSO. This can prevent interference that occurs due to use of a frequency band that can be used by another Basic Service Set (BSS) as a change destination.

Also, in another example, the STA 110 may receive a notification from the AP 101 to change the bandwidth of the operation frequency band. Thus, the STA 110 may change whether or not to transmit a wireless control frame for requesting the start of DSO in response to receiving a notification to change the bandwidth of the operation frequency band from the AP 101.

For example, the STA 110 may receive a Channel Switch Announcement (CSA) or a Beacon signal from the AP 101 and may receive a notification to change the operation frequency band to 20 MHz. In this case, the STA 110 does not transmit a wireless control frame requesting the start of DSO and, in a case where a notification to change the operation frequency band to a bandwidth greater than 20 MHz is received, may request the start of DSO.

According to the present disclosure, the user-friendliness when a communication apparatus that communicates with an access point requests the start of Dynamic Subband Operation (DSO) can be improved.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-061455, filed Apr. 2, 2025, which is hereby incorporated by reference herein in its entirety.

What is claimed is:

1. A wireless communication apparatus capable of communicating with an access point using a wireless frame compliant with an IEEE 802.11 standard series, comprising:
at least one memory that stores a set of instructions; and
at least one processor that executes the instructions, the instructions, when executed, causing the wireless communication apparatus to perform operations comprising:
controlling, based on at least one of an operation status of the access point and a communication environment, whether or not to transmit to the access point a wireless control frame for requesting a start of a Dynamic Subband Operation (DSO) in which a frequency band used in communication between the access point and the wireless communication apparatus is dynamically changed within a range of one operation frequency band used by the access point.

2. The wireless communication apparatus according to claim 1, wherein
the controlling comprises not transmitting the wireless control frame to the access point in a case where the one operation frequency band is included in a 2.4 GHz band, and transmitting the wireless control frame to the access point in a case where the one operation frequency band includes a channel other than a 2.4 GHz band.

3. The wireless communication apparatus according to claim 1, wherein
the controlling comprises not transmitting the wireless control frame to the access point in a case where a bandwidth of the one operation frequency band of the access point is equal to or less than 20 MHz, and transmitting the wireless control frame to the access point in a case where the bandwidth of the one operation frequency band is greater than 20 MHz.

4. The wireless communication apparatus according to claim 3, wherein
the instructions, when executed, further cause the wireless communication apparatus to perform operations comprising:
receiving at least one of a Beacon frame, a Probe Response frame, and an Association Response frame transmitted from the access point, and
the controlling comprises identifying the bandwidth of the one operation frequency band of the access point based on information indicating the one operation frequency band of the access point included in the at least one of the Beacon frame, the Probe Response frame, and the Association Response frame that was received.

5. The wireless communication apparatus according to claim 1, wherein
the instructions, when executed, further cause the wireless communication apparatus to perform operations comprising:
detecting a surrounding access point via an Overlapping Basic Service Set (OBSS) scan, and
the controlling comprises not transmitting the wireless control frame to the access point in a case where an access point that does not support a 40 MHz channel mode for communicating using a 40 MHz band is detected, and transmitting the wireless control frame to the access point in a case where no access point that does not support the 40 MHz channel mode is detected.

6. The wireless communication apparatus according to claim 1, wherein
the instructions, when executed, further cause the wireless communication apparatus to perform operations comprising:
receiving a notification to change a bandwidth of the one operation frequency band from the access point, and
the controlling comprises not transmitting the wireless control frame to the access point in a case where a notification to change the bandwidth to 20 MHz is received, and transmitting the wireless control frame to the access point in a case where a notification to change the bandwidth to greater than 20 MHz is received.

7. The wireless communication apparatus according to claim 1, wherein
the one operation frequency band of the access point includes a first frequency band including a primary channel, and a second frequency band different from the first frequency band,
the instructions, when executed, further cause the wireless communication apparatus to perform operations comprising:
detecting an interference intensity in the second frequency band, and
the controlling comprises not transmitting the wireless control frame to the access point in a case where the detected interference intensity is equal to or greater than a predetermined threshold, and transmitting the wireless control frame to the access point in a case where the detected interference intensity is less than the predetermined threshold.

8. The wireless communication apparatus according to claim 7, wherein
the controlling comprises including a value indicating the detected interference intensity in the wireless control frame.

9. The wireless communication apparatus according to claim 7, wherein
the one operation frequency band includes a plurality of the second frequency band,
the detecting comprises detecting an interference intensity of interference from outside of a network formed by the access point in each of the plurality of second frequency bands, and
the controlling comprises transmitting the wireless control frame to the access point in a case where the detected interference intensity of any one or more of the plurality of second frequency bands is less than the predetermined threshold.

10. The wireless communication apparatus according to claim 1, wherein
the controlling comprises, in a case where the wireless communication apparatus is capable of performing communication using a plurality of communication links with different communication bands, controlling whether or not to transmit the wireless control frame to the access point for each communication link.

11. A control method for a wireless communication apparatus capable of communicating with an access point using a wireless frame compliant with an IEEE 802.11 standard series, the method comprising:
controlling, based on at least one of an operation status of the access point and a communication environment, whether or not to transmit to the access point a wireless control frame for requesting a start of a Dynamic Subband Operation (DSO) in which a frequency band used in communication between the access point and the wireless communication apparatus is dynamically changed within a range of one operation frequency band used by the access point.

12. A non-transitory computer readable storage medium storing a program that causes, when the program is executed, a wireless communication apparatus to perform:
controlling, based on at least one of an operation status of the access point and a communication environment, whether or not to transmit to the access point a wireless control frame for requesting a start of a Dynamic Subband Operation (DSO) in which a frequency band used in communication between the access point and the wireless communication apparatus is dynamically changed within a range of one operation frequency band used by the access point.
